(19) United States
(12) Patent Application Publication
(10) Pub. No.: US 2009/0176074 A1
(43) Pub. Date: Jul. 9, 2009

(54) CONDUCTIVE/ABSORBTIVE SHEET MATERIALS WITH ENHANCED PROPERTIES

(75) Inventors: Steve Sotendahl, Hinsdale, MA (US); Stephen P. Maggio, Lenox, MA (US); Steve Bushhouse, Cary, NC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MeadWestvaco Corporation, Glen Allen, VA (US)

(21) Appl. No.: 12/297,775

(22) PCT Filed: Apr. 30, 2007
(86) PCT No.: PCT/US07/67780

§ 371 Date: Oct. 20, 2008

Related U.S. Application Data
(60) Provisional application No. 60/746,568, filed on May 5, 2006.

(51) Int. Cl. B32B 5/00; B05D 5/12; B32B 37/02

(52) U.S. Cl. 428/208; 428/206; 427/123; 156/60

(57) ABSTRACT

An electrically conductive/electromagnetic energy absorptive sheet material is provided comprising cellulosic fibers mixed with conductive/absorptive fibers or particles. The material may have additional useful properties such as compressibility, biodegradability, and fire retardance.

### REFERENCE TO RELATED APPLICATIONS

This application claims the benefit of priority under 35 U.S.C. §119(e) of U.S. provisional application serial number 60/746568, filed on May 5, 2006, and U.S. provisional application serial number 60/870,480, filed on Dec. 18, 2006, both of which are hereby incorporated by reference in their entireties.

### BACKGROUND

This invention relates generally to paper or paperboard materials having useful conductivity and electromagnetic absorptive properties. Furthermore, the materials may have additional useful properties such as compressibility, biodegradability, and fire retardance.

Currently, electronic devices need to be shielded from various forms of electrical interference to work, safely, properly, and comply with FCC regulations. Products used for shielding are pure metal sheets or box cases, metal tapes, woven metal screens, metal coated plastics, plastics/elastomers containing conductive/absorptive fibers or particles, metallized nonwoven or textile sheets, and textiles with conductive/absorptive fibers. In addition, cables are shielded by incorporating highly permeable, sintered devices onto their ends to absorb electromagnetic energy.

The disadvantages of these products include the high cost, weight, thickness and limited formability of pure metal sheets and screens; the high cost and low conductivity of conductive/absorptive plastics; and the high cost, uniformity, and masking requirements of metal coated plastics. Furthermore, these traditional electromagnetic interference (EMI)/radio frequency interference (RFI) shielding products experience decreasing effectiveness at frequencies above 1.5 GHz.

The invention described here provides a shielding material comprising a conductive/absorptive paper or paperboard product.

### SUMMARY

The present invention provides a paper with a high level of conductivity (low level of resistance) and electromagnetic absorptive properties that in various embodiments can serve a number of useful purposes including shielding against EMI/RFI, protecting against electrostatic discharge, and producing electric resistance heating. The materials may have additional useful properties such as compressibility, biodegradability, and fire retardance.

### BRIEF DESCRIPTION OF THE DRAWINGS

FIG, 1 illustrates a cross section view of a typical fibrous web;

FIGS. 2-5 illustrate cross section views of fibrous webs containing conductive/absorptive fibers in embodiments according to the invention;

FIG. 6 illustrates an exemplary method of making conductive/absorptive fibrous webs in an embodiment according to the invention; and

FIG. 7 illustrates the use of an absorptive tape to provide EM suppression.

### DETAILED DESCRIPTION

FIG. 1 illustrates a microscopic cross section view of a typical fibrous web 100 that includes fibers 102 such as cellulose fibers. The drawing is for illustration purposes and not necessarily to scale. Furthermore it may represent only a portion of the fibrous web, for example one of its surfaces. Typically the fibers would run in several directions, for example in the plane of the cross section as represented by fibers 102, and normal to the plane or at other directions as represented by fibers 104. At points where fibers cross each other more or less in the same plane, as at point 106, or cross each other at other angles such as a skewed crossing as at point 108, there may be some interfiber bonding, for example by hydrogen bonds that may be developed during a wet formation process such as occurs at the wet end of a paper machine. The fibers may typically be prepared by refining or other processes that fibrillate the fibers, so as to enhance the eventual fiber bonding and give greater strength. Additives may also be used as is well known in the art of papermaking.

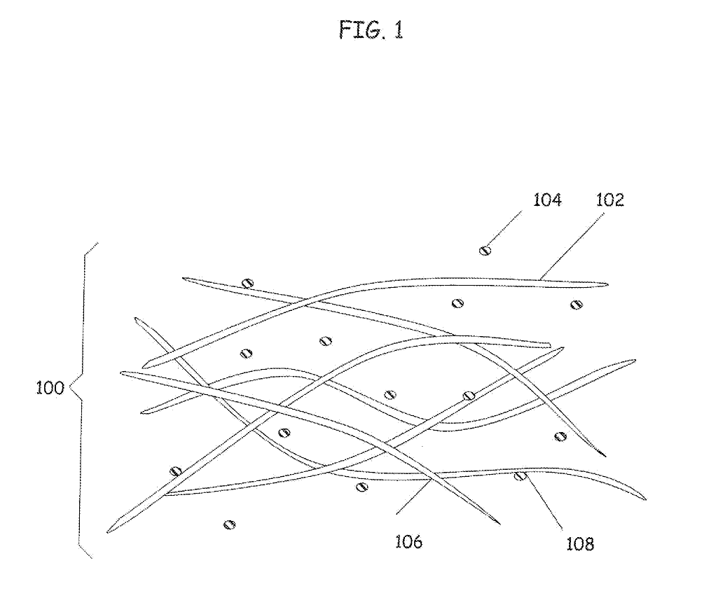

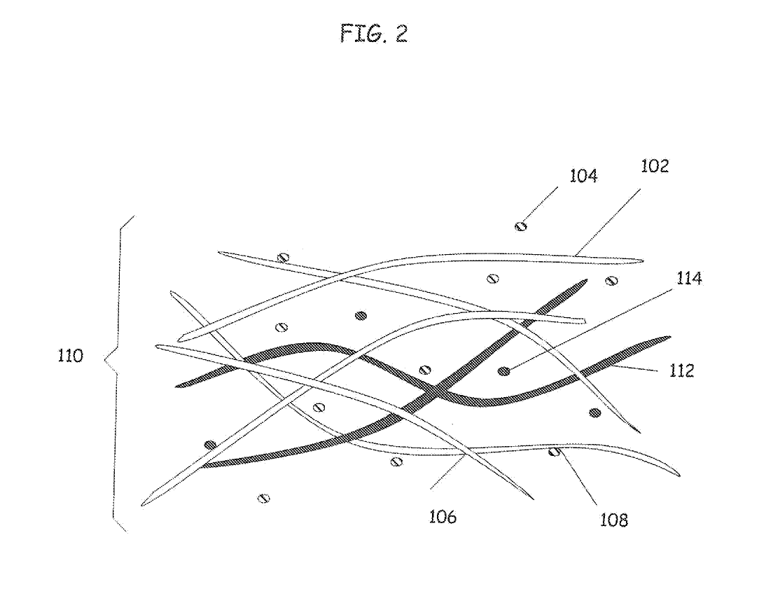

FIG. 2 illustrates a microscopic cross section view of a fibrous web 110 containing conductive/absorptive fibers 112 and 114 according to the invention. For example, conductive/absorptive fibers and/or particles are added to a wood pulp in water and mixed together to form a slurry which is then made into fibrous web 110. The conductive/absorptive fibers and/or particles may be comprised of metal fibers such as stainless steel fibers or copper fibers, metal plated metal fibers such as nickel plated copper fibers, silver plated copper fibers, tin plated copper fibers, carbon fibers or particles, metal plated carbon fibers such as nickel plated carbon fibers, ferrite powders, synthetic fibers made from, a base of various thermoplastics such as polyester which are plated with metal or contain conductive/absorptive carbon particles or fibrets within, or metal coaled glass particles or fibers. The conductive/absorptive fibers maybe completely one type or mixtures of any or all types. The conductive/absorptive fibers are preferably from 2 mm to 20 mm in length. They may comprise from 1% to 50% of the total dry fiber component by weight. The remaining fiber component (99% to 50%) may be wood-based paper making fibers 102, 104 of any softwood or hardwood species and/or cotton. Softwood species are preferred, in addition to the conductive/absorptive fibers or particles and the papermaking fibers in the slurry; a bulking particle may be added. These particles result in an increase in caliper (thickness) for a given basis weight of paper once manufactured. The resulting pulp, particle and water mixture may be made into a dry sheet via web forming processing known to those skilled in the art. One possible forming process is a wet laid process such as a fourdrinier based paper machine. Depending on end use intended, wet strength resins such as melamine formaldehyde or polyacrylepichlorohydrin may be added to the pulp mixture to impart strength when the final paper sheet is rewet. The. final sheet may have a basis weight of 30 gsm to 1200 gsm.

The resistance of the resulting paper sheet would depend on the amount and location of conductive/absorptive material in the sheet. Resistance of this type of product is typically known as “sheet resistance” and is measured in units of “ohms per square.” For convenience here, the term “resistance” will be used. A resistance of less than about one ohm per square would be useful for electromagnetic interference (EMI), or radio frequency interference (RFI), shielding applications. A resistance of about 10-200 ohms per square would be useful for electrostatic discharge (ESD) applications. A resistance of about 1-500 ohms per square would be useful for resistance heating applications. For these particular types of applications, the ranges given here are examples, and resistance values outside the particular ranges may still be useful. For example, resistances between 1-10 ohms per square may still be useful for EMI/RFI shielding, and a resistance outside the range of 10-200 ohms per square may still be useful for BSD applications.

Potential uses for the embodiment of FIG. 2 include use in a decorative laminate for furniture, wall or floor panels which have shielding capability or the ability to be heated (depending on resistance range). In the shielding use, the conductive/absorptive sheet may form one layer of a multilayer laminate structure and may be encased in a melamine formaldehyde, urea formaldehyde or polyester resin based laminate. The decorative laminate may be manufactured using either high pressure or low-pressure methods. The conductive/absorptive sheet layer may be saturated in the chosen resin and added to the decorative laminate at any layer underneath the decorative layer so that it is not visible from the surface of the laminate and does not detract from the decorative aesthetics. Although not required to provide shielding, the conductive sheet now encased in the laminate may be connected to electrical ground to provide additional protection. For heating purposes, the conductive sheet may preferably be positioned in the layer just below the decorative layer so as to be as close to the working surface as possible. The conductive sheet within the decorative laminate may be connected to a power supply at two sides (or ends) of the laminate to form a circuit. This circuit may pass an appropriate electric current through the laminated conductive sheet, producing heat.

The conductive/absorptive sheet may also be used as is (not part of a decorative laminate) inside of cases on all types of equipment needing shielding tor EMI or RFI, for example, in computer housings. The sheet could also be used as a gasket material for EMI shielding applications. The sheet could also be used for architectural shielding applications such as wall coverings. Further, the sheet could be saturated in or encased in a flexible insulating substance such as a styrene butadiene or urethane-acrylic latex and connected to a portable power supply for resistance heating,

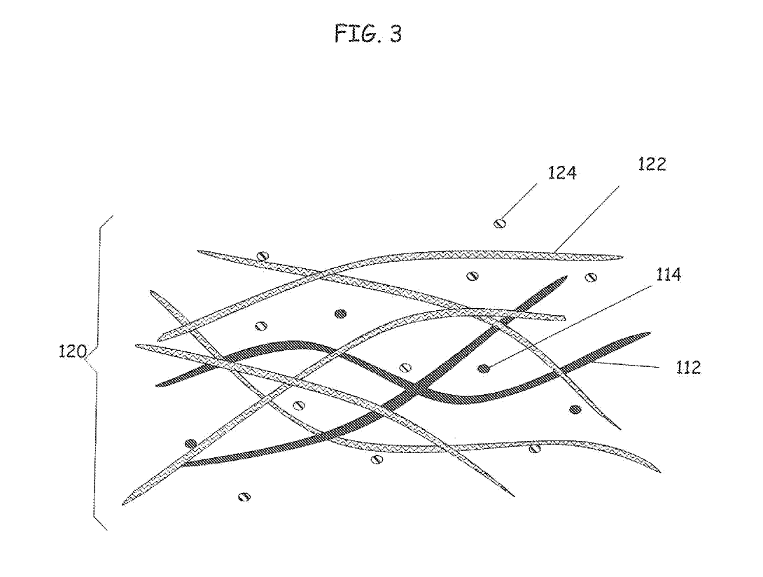

FIG. 3 illustrates a microscopic cross section view of a fibrous web 120 containing conductive/absorptive fibers and/or particles in another embodiment according to the invention. In this example, conductive/absorptive fibers 112, 114 are mixed with synthetic fibers 122, 124 suitable for a wet laid process known to those skilled in the art. The synthetic fibers 122, 124 may include but are not limited to such thermoplastics or manufactured products as polyethylene, polypropylene, polyester, nylon, acrylic, rayon, polyvinyl alcohol (PVOH), polylactic acid (PLA), etc, or fibers formed from synthetics formed in cither dry web forming processes like melt blown, spun bonded, etc. The conductive/absorptive fibers and/or particles may be comprised of metal fibers such as stainless steel fibers or copper fibers, metal plated metal fibers such as nickel plated copper fibers, silver plated copper fibers, tin plated copper fibers, carbon fibers or particles, metal plated carbon fibers such as nickel plated carbon fibers, fertile powders, iron-based powders, synthetic fibers made from a base of various thermoplastics such as polyester which are plated with metal or contain conductive/absorptive carbon particles or fibrets within, or metal coated glass particles or fibers. The conductive/absorptive fibers may be completely one type or mixtures of any or all types. The conductive/absorptive fibers may preferably be from 2 mm to 20 mm in length and more preferably from 2 mm to 6 mm in length. They may comprise from 1% to 50% of the total fiber component by weight. The remaining fiber component (99% to 50%) may be a synthetic fiber suitable for wet laid applications in length and diameter (denier) or a combination of paper making fibers from FIG. 2 and synthetic fiber. The synthetic fiber may have a melting point selected to be compatible with a subsequent heat forming process. Binders may be added to give the sheet strength when manufactured. The binders may include PVOH or polyvinyl acetate (PVA) binder fibers or various latexes. The resulting pulp and binder mixture may then be made into a sheet via conventional wet laid paper making processing know to those skilled in the art such as a fourdrinier based paper machine. The sheet may have a basis weight of 30 gsm to 1200 gsm.

The sheet resistance may depend on the amount of conductive materials therein. A resistance of less than about one ohm per square would be useful for electromagnetic interference (EMI) shielding applications. A resistance of about 10-200 ohms per square would be useful for electrostatic discharge (ESD) applications. A resistance of about 1-500 ohms per square would be useful for resistance heating applications. These ranges are typical examples and as noted earlier, are not meant to be limiting.

Potential uses for the embodiment of FIG. 3 include heat forming or shaping and die cutting into forms to fit into product cases, circuit board covers, or around various electric and electronic components for EMI and/or RFI shielding purposes. It could also be formed into other shapes that conform to a body for electrical resistance heating.

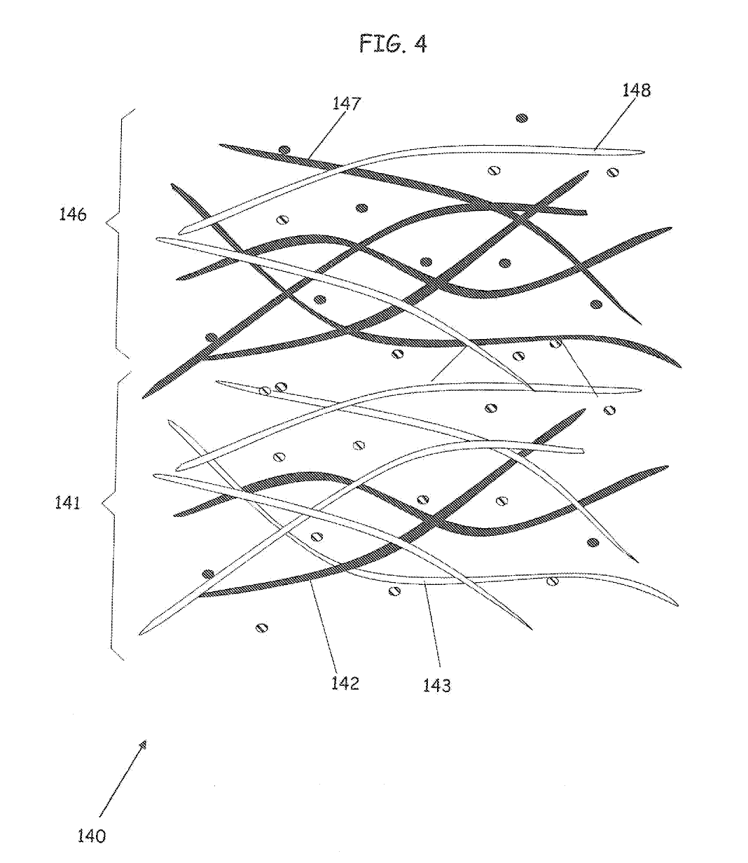

FIG. 4 illustrates a microscopic cross section view of a fibrous web 140 containing conductive/absorptive fibers in another embodiment according to the invention. A portion of conductive/absorptive fibers 142 (such as the types of materials mentioned above) may be mixed with wood pulp fibers 143 in water to form layer 141. while additional conductive/absorptive fibers 147 and optionally wood pulp fibers 148 may be added to water separately and then applied in a layer 146 on one side of the paper sheet during manufacture. The relative thicknesses of the layers are not necessarily to scale. The conductive/absorptive fibers added to layer 146 on one side of the sheet could be of the same type as those mixed with the wood pulp fibers to form layer 141, or could be a different type(s). The conductive/absorptive fibers may preferably be from 2 mm to 20 mm in length. From 1% to 99% of the total conductive/absorptive fiber component by weight in the web 140 may be in layer 141, The remaining fiber component in layer 141 would be wood pulp based (see above for types) known to those skilled in the art. The remaining conductive/absorptive fiber component that, is not in layer 141 would be in layer 146.

Layer 146 may be almost, pure conductive/absorptive fiber (>90%)

having less than 10% wood fibers mixed in. The application method for the conductive/absorptive layer 146 may include a secondary headbox on the fourdrinier, a slot (curtain) coater or other wet laid system. The resulting paper sheet made from this process has a base layer 141 composed of a mixture of conductive/absorptive fibers and wood pulp. The base layer 141 may optionally have wet strength resin added, such as the resin types described above. The forming of the base layer 141 may be by the same wet laid systems mentioned above. The final sheet may additionally have a second layer 146 on one side which is composed almost entirely of conductive/absorptive fibers. Basis weight ranges and resistance ranges may be similar to those given for above embodiments.

To explain further, one possible example of the embodiment of FIG. 4 could be a 100 gsm conductive/absorptive sheet. The sheet would be 50% (50 gsm) conductive/absorptive fibers and 50% (50 gsm) wood based softwood fibers. The embodiment would be comprised of two layers. The conductive/absorptive fibers would be split 50/50 between the layers. The resulting base layer 141 would contain the 50 gsm of softwood fibers and half the 50 gsm of conductive/absorptive fiber, or 25 gsm, for a total of 75 gsm. The second layer 146 would be comprised of the remaining conductive/absorptive fibers, 25 gsm. The two layers together would comprise the total sheet, of 100 gsm.

Potential uses of this embodiment are the same as for the first embodiment.

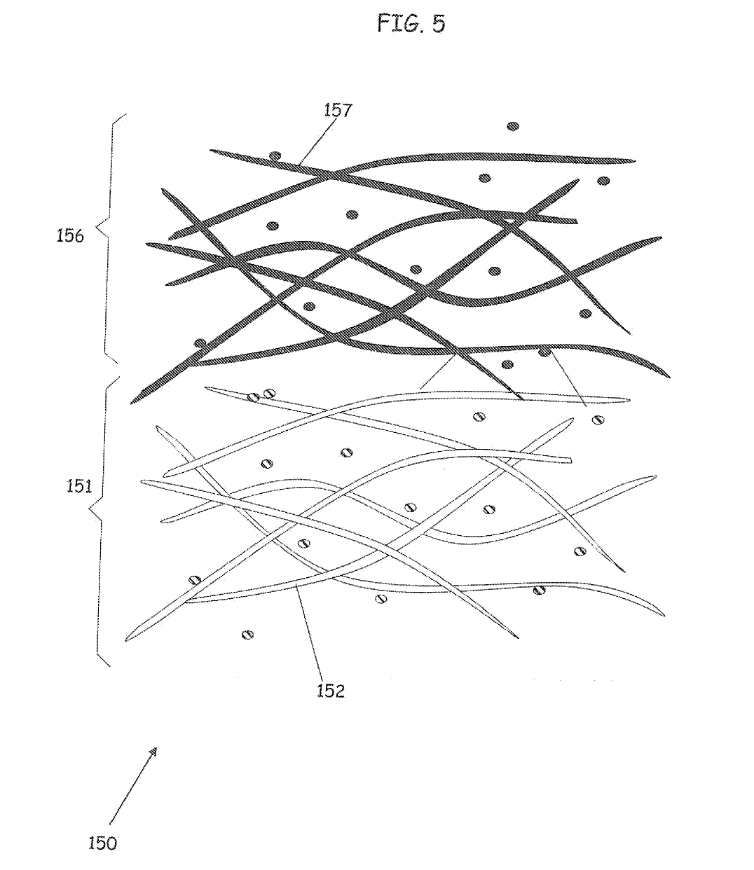

FIG. 5 illustrates a microscopic cross section view of a fibrous web 150 containing conductive/absorptive fibers in another embodiment according to the invention. In this example, the paper sheet may have a base layer 151 of pure or nearly pure wood pulp fibers 152 of types described in FIG. 2 and a second layer 156 comprising all or nearly all conductive/absorptive fibers 157 may be added as a layer on one side of the paper sheet via the application methods mentioned above. The types of conductive/absorptive fibers may be the same as for the embodiment of FIG. 2, The different types of conductive/absorptive fibers or particles could be used singly or in any combination.

Potential uses of this embodiment are the same as for the first embodiment.

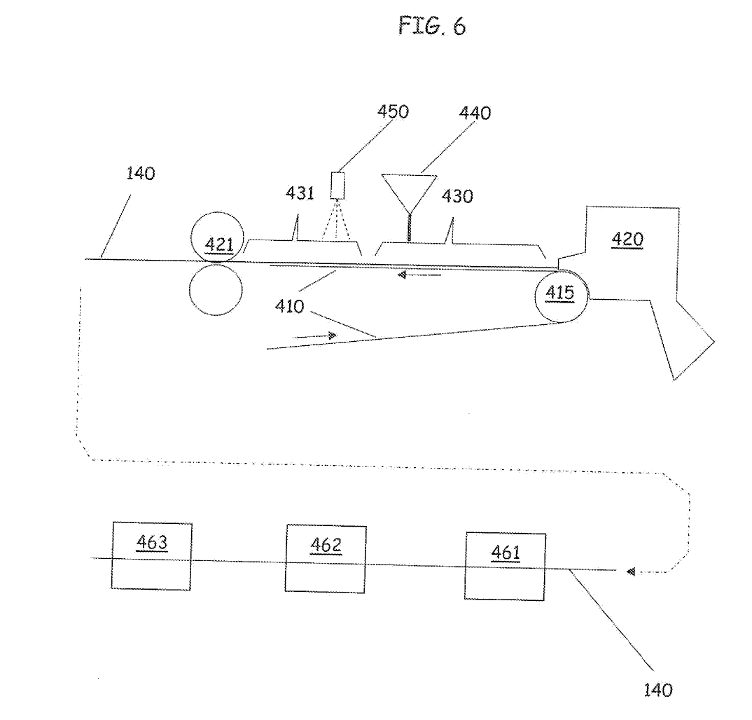

FIG. 6 illustrates an exemplary method for making the conductive/absorptive paper or paperboard (such as 140) using a paper machine. A forming wire 410 in the form of an endless belt, passes over a breast roll 415 that rotates proximate to a headbox or primary headbox 420. The head box provides a fiber slurry in water with a fairly low consistency (for example, about 0.5% solids) that passes onto the moving forming wire 410. During a first distance 430 water drains from the slurry and through the forming wire 410, forming a web of wet fibers. The slurry during distance 430 may yet have a wet appearance as there is free water on its surface. At some point as drainage continues the free water may or may not disappear from the surface, and over distance 431, water may continue to drain, although the surface appears free from water. Eventually the web is earned (for example by transfer felt or press felt, not shown) through one or more pressing devices such as press roils 421 that help to further dewatering the web, usually with the application of pressure, vacuum, and sometimes heat. After pressing, the web is dried. These steps as described so far are well known in the art of papermaking.

As an example, conductive/absorptive material such as fibers or particles may be added to the slurry in an earlier stage of the slurry preparation, or before or in the headbox, or shortly after leaving the headbox. Addition at these locations provides good mixing throughout, the slurry. Standard papermaking practice is to try to achieve uniform distribution of solids in the slurry, leading to good “formation” of the paper product. If the conductive/absorptive materials have different physical or chemical properties from the usual paper fibers, additives may be used to achieve desired results, such as keeping all materials uniformly in suspension. The point at which conductive/absorptive fibers are added may influence their orientation in the web.

Conductive/absorptive materials may be added when the web being formed has just left the headbox, and is fairly fluid, for example in the first distance 430. Material added at this point, whether liquid or solid, may be less likely to distribute evenly because the slurry of fibers is becoming set. Therefore migration of the conductive/absorptive materials across the web or into the web may be somewhat limited.

Conductive/absorptive materials may be added when the web being formed is further away from the headbox, and less fluid, for example in the second distance 431. Materials added at this point may be expected to remain closer to the surface of the web. Possible application methods for conductive/absorptive materials include, for example, a curtain coater 440, or a spray coater 450, or a secondary headbox (not shown).

Conductive/absorptive materials, besides being added to the web at the “wet end” of the paper machine, for example in locations 430, 431, may also be added at other locations toward the dry end of the paper machine. Typically one or more drying sections such as 461, 462, and 463 may be used to dry the paper. Addition of conductive absorptive materials could occur within or between these drying sections. This could be done using application methods which include but are not limited to a curtain coater, a spray coater, or a size press (not shown).

The conductive/absorptive sheet disclosed herein has several advantages over other conductive/absorptive materials. It may be produced at lower cost due to low cost, base materials and reduced need for expensive conductive/absorptive additives. It may be made with high conductivity and high uniformity. The sheet is more flexible than metal sheets or screens. There is no secondary processing required, eliminating the need for plating, painting, or masking compared to both metals and plastics. Also, in a certain embodiment, the conductive/absorptive sheet is thermoformable.

Additional Embodiments

Besides the embodiments described so far, certain materials may be selected for making the conductive/adsorptive products in order to give additional desired properties.

Certain materials used for EMI shielding are not biodegradable or environmentally friendly. With the increasingly short lifetime of many electrical devices, most of them end up in landfills. With use of appropriate materials as described below, EMI shielding materials may be made completely biodegradable and environmentally friendly.

Fire resistant or lire retardant properties are often desired or necessary for materials used in electromagnetic shielding. A material that is fire retardant will prevent the propagation of fire/flame once a heat source is removed. Except for the pure metal forms of shielding (boxes, tapes, spring gaskets, etc), many shielding products used are not fire retardant/resistant or must have special additives to be fire retardant.

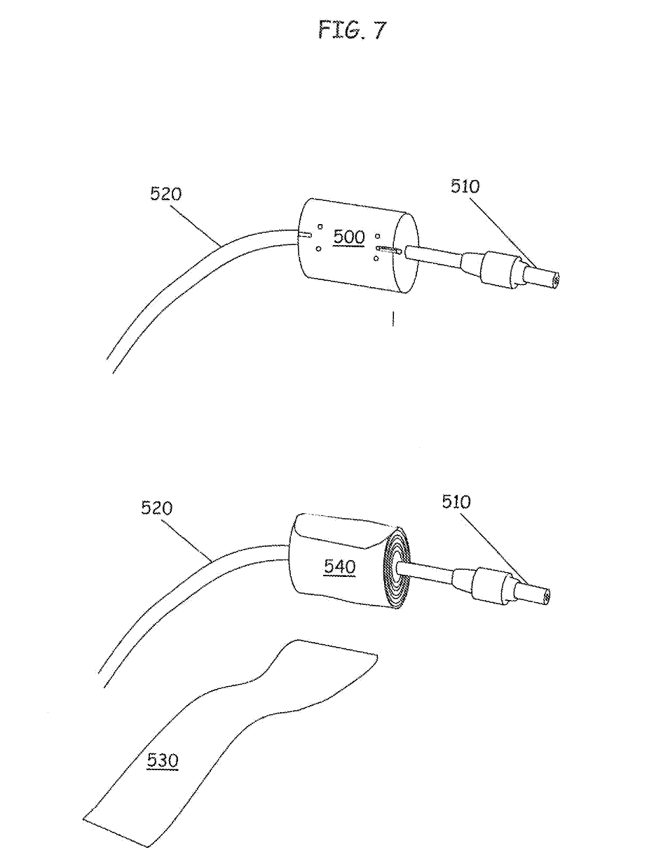

Electromagnetic absorptive properties are also very desirable in many suppression, devices found on electric cables and power cords. These devices, such as device 500 in FIG. 7, usually appear as a cylindrical bulge near an end 510 of the cable 520, typically are magnetically permeable materials, such as ferrites and other iron based powders, sintered into a functional device that fits over a cable and suppresses interference. These sintered devices are very rigid and inflexible. Their geometry and composition are critical to achieving optimal functionality. Therefore, a large variety of shapes, sizes, and compositions are needed to fit the wide variety of applications. The ferrite composition is naturally fire retardant. For ease of assembly and protection, many of these devices are contained in molded plastic housings, either solid or split, which are either inserted over or clamped over the cables. These housings add unnecessary cost and do not contribute to the functionality of the device, and the molded case is typically not tire retardant.

In another example, magnetically permeable materials, such as ferrites and other iron based powders, are added to elastomer sheets, or coated on polymer sheets to function as microwave absorbers. These materials are then attached to various surfaces to absorb microwaves or radar, for example as cavity resonance absorbers for circuit boards, etc. The elastomers used to make these products are not fire retardant, so that in some instances, additional lire retardant substances are added to make the products fire retardant.

Compressibility is sometimes desired for EMI shielding applications. Gaskets are often used at joints in a structure such as a computer case. These gaskets are typically compressible, foam cores covered with a conductive fabric or foil. They are adhered to the surfaces with pressure sensitive adhesive strips.

Embodiments are described below which provide among other benefits biodegradability, fire retardance, absorptive properties, compressibility, and ease of shaping into functional components. It should be understood, that most of the additional features incorporated into these embodiments can be combined with each other, or with the embodiments previously described. For example, biodegradability and compressibility may both be incorporated into a product. Likewise formability and fire retardance may be incorporated together. Other combinations are also possible.

Biodegradability

Referring to the embodiments already described, a biodegradable and environmentally friendly product may be achieved using carbon fibers or particles tor the conductive/absorptive fibers and/or particles. The conductive/absorptive carbon fibers are preferably from 2 mm to 20 mm in length, and carbon particles are preferably from 1 to 20 microns in diameter. The carbon fibers or particles may comprise from 10% to 50% of the total dry fiber component by weight. The remaining fiber component (90% to 50%) may be wood-based paper making fibers 102, 104 of any softwood or hardwood species and/or cotton. Softwood species are preferred. The resulting pulp, particle and water mixture may be made into a dry sheet via web forming processing known to those skilled in the art. One possible forming process is a wet laid process such as a fourdrinier based paper machine. Depending on end use intended, a biodegradable binder such as natural rubber may be added to the pulp mixture to impart strength when the final paper sheet is rewet. The final sheet may have a basis weight of 30 gsm to 1200 gsm.

In an embodiment similar to FIG. 3, a fibrous web 120 contains conductive/absorptive carbon fibers and/or particles. In this embodiment, conductive/absorptive carbon fibers 112, 114 or carbon particles are mixed with biodegradable synthetic fibers 122, 124 suitable for a wet laid process known to those skilled in the art. The biodegradable synthetic fibers 122, 124 may include without limitation PLA, starch, and cellulose based polymers. The conductive/absorptive carbon fibers may preferably be from 2 mm to 20 mm in length. Carbon particles maybe from 1 to 20 microns in diameter. Carbon fibers or particles may comprise from 10% to 50% of the total weight of the sheet. The remaining fiber component (90% to 50%) may be a mix of biodegradable polymers and wood pulp, and/or cotton fibers suitable for wet laid applications in length and denier (diameter). The biodegradable polymers may have a melting point selected to be compatible with a subsequent heat forming process. A biodegradable binder such as natural rubber may be added to give the sheet strength when manufactured. The resulting pulp and binder mixture may then be made into a sheet via conventional wet laid paper making processing know to those skilled in the art such as a fourdrinier based paper machine, inclined wire, cylinder, rotoformer. or gap forming process, in another embodiment, the biodegradable binder may be added to the conductive sheet after manufacture via saturation or coating. Depending on intended end use, biodegradable wet strength resins may also be added to the pulp mixture to impart strength when the final sheet is rewet. The sheet may have a basis weight of 30 gsm to 1200 gsm.

Potential uses for the embodiment include heat forming or shaping and die cutting into forms to lit into product cases, circuit board covers, or around various electric and electronic components for EMI and/or RFI shielding purposes.

In another embodiment, similar to that shown in FIG. 4, portion of conductive/absorptive fibers 142 (in this case carbon fibers, or carbon particles, which are biodegradable) maybe mixed with wood pulp fibers 143 in water to form layer 141, while additional conductive/absorptive fibers 147 (in this case carbon fibers, or carbon particles) and optionally wood pulp fibers 148 may be added to water separately and then applied in a layer 146 on one side of the paper sheet during manufacture. The relative thicknesses of the layers are not necessarily to scale. The biodegradable conductive/absorptive fibers or particles added to layer 146 on one side of the sheet could be of the same type as those mixed with the wood pulp fibers to form layer 141, or could be a different biodegradable type(s). Conductive/absorptive carbon fibers may preferably be from 2 mm to 20 mm in length. Carbon particles may preferably be from 1 to 20 microns in diameter. The carbon fibers or particles may be from 10 to 50% by weight of the sheet. From 10% to 50% of the total conductive/absorptive carbon fiber or particle component by weight in the web 140 may be in layer 141. The remaining fiber component in layer 141 would be wood pulp based (see above for types) known to those skilled in the art. The remaining conductive/absorptive carbon fiber or particle component that is not in layer 141 would be in layer 146.

Layer 146 may be almost pure conductive/absorptive carbon fiber or

particles (>90%) having less than 10% wood fibers mixed in. The application method for the conductive/absorptive layer 146 may include a secondary headbox on the fourdrinier, a slot (curtain) coater or other wet laid system. T he resulting paper sheet made from this process has a base layer 141 composed of a mixture of conductive/absorptive fibers and wood pulp. The base layer 141 may optionally have a biodegradable binder added, such as natural rubber for strength. The forming of the base layer 141 may be by the same wet laid systems mentioned above. The final sheet may additionally have a second layer 146 on one side which is composed almost entirely of conductive/absorptive carbon fibers or particles. Basis weight ranges and resistance ranges may be similar to those given for above embodiments.

As was illustrated in FIG. 5, a fibrous web 150 may have a base layer 151 of pure or nearly pure wood pulp fibers 152 of types described in FIG. 2, and a second layer 156 comprising all or nearly ail conductive/absorptive carbon fibers 157 or particles may be added as a layer on one side of the paper sheet via: the application methods mentioned above. Optionally, a biodegradable binder such as natural rubber may be added for strength. Depending on end use intended, biodegradable wet strength resins could also be added to the pulp mixture to impart strength when the final paper sheet is rewet.

Fire Retardance

To impart fire retardance to the sheet products previously described

herein, addition may be made of a fire retardant material or mixture of materials included without limitation metal hydroxides (for example aluminium trihydrate, calcium sulfate dehydrate, magnesium hydroxide, and talc), antimony compounds such as antimony trioxide, boron compounds such as borax and zinc borate; metal compounds including those based on zinc, molybdenum, and titanium, and phosphorus compounds (such an ammonium polyphosphate). The fire retardant material or mixture of materials may comprise 5 to 50% of the dry weight of the pulp mixture. Charged chemicals may optionally be added to improve the retention of the fire retardants with the fibers, in an additional embodiment, a sheet either with or without internal fire retardant materials could have fire retardant materials (such as those listed, above, and other water soluble fire retardants such as boric acid or ammonium bromide) added via a liquid spray, size press, or coalers (such as a slot coater, rod coater, roll coater. etc.) Additionally, these fire retardants may be added after manufacturing the sheet on a paper machine, via an off-machine saturator, coater, or size press. These fire retardants applied to the sheet may add 1 to 50% additional dry weight to the sheet.

The fire retardant sheet may be formed in more than one layer. To explain further, one possible example similar to the structure of FIG. 4 could be a 115 gsm conductive/absorptive sheet. The example sheet would be 43.5% (50 gsm) conductive/absorptive fibers 43.5% (50 gsm) wood based softwood fibers and 13% (15 gsm) of polyphosphate filler. The embodiment maybe comprised of two layers. The conductive/absorptive fibers and filler may be split 50/50 between the layers. The resulting base layer would contain the 50 gsm of softwood fibers and half the 50 gsm of conductive/absorptive fiber (25 gsm) and half the 15 gsm filler (7.5 gsm), for a total of 82.5 gsm. The second layer would be comprised of the remaining conductive/absorptive fibers and retardant filler, or 32.5 gsm. The two layers together would comprise the total sheet of 115 gsm. Additionally this sheet may be further coated with fire retardant materials as described above.

Various latex binders may be added to the pulp mixture to impart strength and durability to the final sheet. Any type of latex may be used for the purpose including natural rubbers, styrene butadiene, acrylic, etc. The latex may be added in several ways known to those skilled in the art. These include addition of the latex to the pulp slurry (wet end addition), addition via a size press or coater on the paper machine during sheet manufacture, or addition after manufacture on a coater, size press, or saturator. When the latex is added post wet end, fire retardant fillers and/or borates may be mixed in with the latex prior to its addition to the sheet.

Compressibility

In another embodiment, unexpended microspheres, such as Akzo Nobel's Expancel Microspheres, may be added to the sheet structures already described, for example by mixing the microspheres into the slurry being made into a sheet material. Conductive fibers and/or particles would comprise from 10% to 50% of the total dry fiber component by weight. The microspheres would comprise 2 to 40% of the dry mixture. The remaining fiber component (10% to 88%) would be normal wood based paper making fibers of any softwood or hardwood species, although softwood species are preferred, or cotton fibers, Upon expansion, typically achieved through controlled application of heat, the microspheres would have a diameter from 5 to 50 microns each and would lend compressibility to the sheet. Compressibility is useful, for example in gasket applications.

In one embodiment, the microspheres may be used in a multi-layer sheet, such as those described previously. It may be advantageous to provide the majority or all of the microspheres in one of the layers.

Use of Ferrite Materials

Electric cables and power cords can act as antennas if not properly shielded and can induce unwanted radio frequency interference into the electronic components they are connected to. To prevent this, magnetically permeable materials, such as ferrites and other iron based powders, are sintered into a functional device that fits over these cables and suppresses the unwanted interference. For example, as shown in FIG. 7, a suppressor device 500 typically appears as the common cylindrical bulge located near the ends 510 of computer cable 520.

A ferrite containing sheet may be created by the invention to provide the same functionality as existing sintered ferrite devices, without the need for a plastic housing, and reducing the inventory of sizes needed for the different applications. The material may be converted into a tape 530 and secured to a cable 520 with an adhesive backing, glue, or other appropriate mechanism. For example, by wrapping such a tape 530 around a cable 520, a suppressor device 540 may be created. By using a tape design, the inside diameter of the suppression material device 540 will perfectly fit the outside diameter of the cable 520, and the overall outside diameter of the device can be varied by the number of tape wraps around the cable. Therefore two of the geometry variables that cause the large inventory of sintered parts are eliminated.

Another use of a ferrite containing flexible sheet is for a microwave absorber in various applications such as radar absorbing and cavity resonance absorbing materials. These materials could also be converted into a tape and secured to the appropriate surfaces with an adhesive backing, glue, or other appropriate mechanism.

To create the desired absorptive sheet, magnetically permeable materials comprised of various carbon, ferrite and/or iron based powders, maybe added to a wood pulp and water mixture. The powder fillers could be added to the pulp and water slurry prior to the sheet forming process, or they could be added via a secondary apparatus to a base of fibers during the forming process (such as on the fourdrinier).

The sheet may have a basis weight of 100 gsm to 3000 gsm. The highly permeable powders may comprise 40-80% by weight of the mixture and may have an average particle size between 1-70 microns. The resulting sheet may then be slit to the appropriate width for each application. An adhesive backing may also be added to the material, to make a tape.

Methods of making and using the absorptive fibrous web in accordance with the invention should be readily apparent from the mere description of the product structure and its varied appearances as provided herein. No further discussion or illustration of such methods, therefore, is deemed necessary.

While preferred embodiments of the invention have been described and illustrated, it should be apparent that many modifications to the embodiments and implementations of the invention can be made without departing from the spirit or scope of the invention. Although the preferred embodiments illustrated herein have been described in connection with one and two-layer sheets, and with particular types of conductive/absorptive and non-conductive materials, these embodiments may easily be implemented in accordance with the invention in sheets having more than two layers, and comprising other conductive/absorptive and nonconductive materials.

It is to be understood therefore that, the invention is not limited to the particular embodiments disclosed (or apparent from the disclosure) herein, but only limited by the claims appended hereto.

1. An electrically conductive/electromagnetic energy absorptive sheet material comprising
nonconductive fibers; and
conductive/absorptive fibers or particles sufficient to give useful conductive/absorptive properties, wherein said conductive/absorptive fibers or particles are interspersed with or mixed together with said nonconductive fibers.

2. The conductive/absorptive sheet material of claim 1, wherein said nonconductive fibers comprise cellulose fibers.

3. The conductive/absorptive sheet material of claim 1, wherein said nonconductive fibers comprise synthetic fibers.

4. The conductive/absorptive sheet material of claim 1, wherein said nonconductive fibers comprise a mixture of cellulose and synthetic fibers.

5. The conductive/absorptive sheet of claim 1, wherein said conductive/absorptive fibers or particles and said nonconductive fibers are biodegradable.

6. The conductive/absorptive sheet of claim 1, wherein said conductive/absorptive fibers or particles are carbon and said nonconductive fibers are cellulose or biodegradable synthetic fibers.

7. The conductive/absorptive sheet material of claim 1, wherein said conductive/absorptive fibers or particles are comprised of metal, metal plated metal, carbon, metal plated carbon, ferrite powder, iron-based powder, metal plated glass, or synthetic fibers that are metal plated or contain conductive/absorptive particles or fibrets within.

8. The conductive/absorptive sheet material of claim 1, wherein said conductive/absorptive fibers or particles comprise stainless steel fibers, copper fibers, aluminum fibers, nickel plated copper fibers, silver plated copper fibers, or tin plated copper fibers.

9. The conductive/absorptive sheet material of claim 1, wherein said conductive/absorptive fibers or particles comprise about 1% to 80% of the total dry weight of the sheet.

10. The conductive/absorptive sheet material of claim 1, wherein said conductive/absorptive fibers or particles are provided in the slurry feed to a headbox.

11. The conductive/absorptive sheet material of claim 1, wherein said conductive/absorptive fibers or particles are provided in the slurry feed to a primary headbox.

12. The conductive/absorptive sheet material of claim 1, wherein said conductive/absorptive fibers or particles are provided in the slurry feed to a secondary headbox.

13. The conductive/absorptive sheet material of claim 1, wherein said conductive/absorptive fibers or particles are provided through a slot or curtain coater.

14. The conductive/absorptive sheet material of claim 1, wherein said conductive/absorptive fibers or particles are provided through a sprayer.

15. The conductive/absorptive sheet material of claim 1, wherein said conductive/absorptive fibers or particles are distributed evenly throughout said sheet.

16. The conductive/absorptive sheet material of claim 1, wherein said conductive/absorptive fibers or particles are distributed preferentially to at least one surface of said sheet.

17. The conductive/absorptive sheet of claim 1, formed in more than one layer of fibers.

18. The conductive/absorptive sheet material of claim 1, wherein said conductive/absorptive fibers or particles are contained between two nonconductive fiber layers.

19. The conductive/absorptive sheet of claim 1, further comprising a fire retardant material.

20. The conductive/absorptive sheet of claim 1, further comprising expansible microspheres.

21. The conductive/absorptive sheet of claim 1, further comprising a binder.

22. The conductive/absorptive sheet of claim 1, further comprising a biodegradable binder.

23. The conductive/absorptive sheet of claim 1, further comprising an adhesive on at least one side.

24. The conductive/absorptive sheet of claim 1, formed into a tape.

25. The conductive/absorptive sheet material of claim 1, having a surface resistance suitable for at least one of electromagnetic shielding, electromagnetic interference shielding, radio frequency shielding, radio frequency interference shielding, microwave shielding, microwave interference shielding, electrostatic discharge protection, or resistance heating.

26. The conductive/absorptive sheet material of claim 1, comprising conductive/absorptive fibers or particles in an amount sufficient to provide electromagnetic shielding.

27. The conductive/absorptive sheet material of claim 1, comprising conductive/absorptive fibers or particles in an amount sufficient to provide radio frequency shielding.

28. The conductive/absorptive sheet material of claim 1, comprising conductive/absorptive fibers or particles in an amount sufficient to provide microwave frequency shielding.

29. The conductive/absorptive sheet material of claim 1, comprising conductive/absorptive fibers or particles in an amount sufficient to provide electrostatic discharge protection.

30. The conductive/absorptive sheet material of claim 1, comprising conductive/absorptive fibers or particles in ah amount sufficient to provide resistance heating.

31. The conductive/absorptive sheet material of claim 1, used in a laminate structure.

32. The conductive/absorptive sheet material of claim 1, used in a thermoformed structure.

33. The absorptive sheet material of claim 1, used as a cavity resonance suppressing material for circuit board covers.

34. The absorptive sheet material of claim 1, used as an interference absorber for electric cables.

35. The conductive/absorptive sheet material of claim 1, used in lining or covering at least a portion of an enclosure for electronic circuitry, or electrical or electronic components.

36. The conductive/absorptive sheet material of claim 1, used as a conductive/absorptive gasket material for shielding applications.

37. The conductive/absorptive sheet material of claim 1, used as a conductive/absorptive sheet material for architectural shielding applications.

38. A process for making a conductive/absorptive sheet material, comprising:
providing a slurry of both conductive/absorptive fibers or particles and nonconductive fibers; and
applying said slurry onto a porous support and draining the liquid from said slurry to form a mat or web; and drying said mat or web to form a sheet with conductive/absorptive properties.

39. The process of claim 38, wherein said nonconductive/absorptive fibers comprise cellulose fibers.

40. The process of claim 38, wherein said nonconductive fibers comprise synthetic fibers.

41. The process of claim 38, wherein said nonconductive fibers comprise a mixture of cellulose and synthetic fibers.

42. The process of claim 38, wherein said conductive/absorptive fibers or particles and said nonconductive fibers are biodegradable.

43. The process of claim 38, wherein said conductive/absorptive fibers or particles are carbon and said nonconductive fibers are cellulose or biodegradable synthetic fibers.

44. The process of claim 38, wherein said conductive/absorptive fibers or particles are comprised of metal, carbon, nickel plated carbon, ferrite powder, iron-based powder or synthetic fibers that contain conductive/absorptive carbon particles or fibrets within.

45. The process of claim 38, wherein said conductive/absorptive fibers or particles comprise stainless steel fibers, copper fibers, aluminum fibers, nickel plated copper fibers, silver plated copper fibers, or tin plated copper fibers.

46. The process of claim 38, wherein said conductive/absorptive fibers or particles comprise about 1% to 80% of the total dry weight of said mat or web.

47. The process of claim 38, wherein said conductive/absorptive fibers or particles are provided in a slurry feed to a headbox.

48. The process of claim 38, wherein said conductive/absorptive fibers or particles are provided in a slurry feed to a primary headbox.

49. The process of claim 38, wherein said conductive/absorptive fibers or particles are provided in a slurry feed to a secondary headbox.

50. The process of claim 38, wherein said conductive/absorptive fibers or particles are provided through a slot or curtain coater.

51. The process of claim 38, wherein said conductive/absorptive fibers or particles are provided through a sprayer.

52. The process of claim 38, wherein said conductive/absorptive fibers or particles are distributed evenly throughout said mat or web

53. The process of claim 38, wherein said conductive/absorptive fibers or particles are distributed unevenly throughout said mat or web.

54. The process of claim 38, wherein said conductive/absorptive fibers or particles are distributed preferentially to at least one surface of said mat or web.

55. The process of claim 38, wherein said conductive/absorptive fibers or particles are contained between two nonconductive fiber layers.

56. The process of claim 38, further comprising the addition of a fire retardant material to said slurry or as a coating.

57. The process of claim 38, further comprising an addition of expansible microspheres to the mat or web.

58. The process of claim 38 further comprising the addition of a binder material to said slurry.

59. The process of claim 38, further comprising a lamination step applied to the mat or web produced thereby.

60. The process of claim 38, further comprising a thermoforming step applied to the mat or web produced thereby.

61. The process of claim 38, further comprising a step of binder application or saturation carried out On the mat or web produced thereby.

62. A process for making a conductive/absorptive sheet material, comprising:
providing a first slurry comprising at least nonconductive fibers and optionally conductive/absorptive fibers or particles;
providing a second slurry comprising at least conductive/absorptive fibers or particles and optionally nonconductive fibers;
applying said first slurry onto a porous support and draining at least a portion of the liquid from said first slurry to form a mat or web;
applying said second slurry onto said mat or web; and
drying said mat or web to form a sheet with conductive/absorptive properties.

63. The process of claim 62, wherein said nonconductive/absorptive fibers comprise cellulose fibers.

64. The process of claim 62, wherein said nonconductive fibers comprise synthetic fibers.

65. The process of claim 62, wherein said nonconductive fibers comprise a mixture of cellulose and synthetic fibers.

66. The process of claim 62, wherein said conductive/absorptive fibers or particles and said nonconductive fibers are biodegradable.

67. The process of claim 62, wherein said conductive/absorptive fibers or particles are carbon and said nonconductive fibers are cellulose or biodegradable synthetic fibers.

68. The process of claim 62, wherein said conductive/absorptive fibers or particles are comprised of metal, carbon, nickel plated carbon, ferrite powder, iron-based powder or synthetic fibers that contain conductive/absorptive carbon particles or fibrets within.

69. The process of claim 62, wherein said conductive/absorptive fibers or particles comprise stainless steel fibers, copper fibers, aluminum fibers, nickel plated copper fibers, silver plated copper fibers, or tin plated copper fibers.

70. The process of claim 62, wherein said conductive/absorptive fibers or particles comprise about 1% to 80% of the total dry weight of said mat or web.

71. The process of claim 62, wherein said conductive/absorptive fibers or particles are provided in a slurry feed to a headbox.

72. The process of claim 62, wherein said conductive/absorptive fibers or particles are provided in a slurry feed to a primary headbox.

73. The process of claim 62, wherein said conductive/absorptive fibers or particles. are provided in a slurry feed to a secondary headbox.

74. The process of claim 62, wherein said conductive/absorptive fibers or particles are provided through a slot or curtain coater.

75. The process of claim 62, wherein said conductive/absorptive fibers or particles are provided through a sprayer.

76. The process of claim 62, wherein said conductive/absorptive fibers or particles are distributed evenly throughout said mat or web

77. The process of claim 62, wherein said conductive/absorptive fibers or particles are distributed unevenly throughout said mat or web.

78. The process of claim 62, wherein said conductive/absorptive fibers or particles are distributed preferentially to at least one surface of said mat or web.

79. The process of claim 62, wherein said conductive/absorptive fibers or particles are contained between two nonconductive fiber layers.

80. The process of claim 62, further comprising the addition of a fire retardant material to said first or second slurry or as a coating.

81. The process of claim 62, further comprising an addition of expansible microspheres to the mat or web.

82. The process of claim 62 further comprising the addition of a binder material to said first or second slurry.

83. The process of claim 62, further comprising a lamination step applied to the mat or web produced thereby.

84. The process of claim 62, further comprising a thermoforming step applied to the mat or web produced thereby.

85. The process of claim 62, further comprising a step of binder application or saturation carried out on the mat or web produced thereby.
